(19) United States
(12) Patent Application Publication
(10) Pub. No.: US 2013/0091001 A1
(43) Pub. Date: Apr. 11, 2013

(54) Behavior-Based Online Deal Transactions

(71) Applicants: JACK JIA, Los Altos Hills, CA (US); Scott Brenner Brave, San Jose, CA (US)

(72) Inventors: JACK JIA, Los Altos Hills, CA (US); Scott Brenner Brave, San Jose, CA (US)

(73) Assignee: Baynote, Inc., San Jose, CA (US)

(21) Appl. No.: 13/437,809

(22) Filed: Apr. 2, 2012

Related U.S. Application Data
(63) Continuation-in-part of application No. 12/912,608, filed on Oct. 26, 2010.
(60) Provisional application No. 61/516,358, filed on Apr. 1, 2011.

(51) Int. Cl. G06Q 30/02

(52) U.S. Cl. CPC G06Q 30/0224
USPC 705/14.25; 705/14.49

(57) ABSTRACT

A system and method are provided for offering product deals to users based on the online behavior and other information of groups of users. This information associated with multiple users within groups and individuals having common interests in products to be purchased online and information associated with a finite set of data elements in the computer application are analyzed to determine a configuration of the data elements such that user access to relevant information and shopping deals is improved. In some embodiments, deals are offered to “swarms” of individuals with common interest and are made active upon acceptance of the deal by a minimum number of buyers. Deals may be automatically generated based on parameters defined by a vendor.

### RELATED APPLICATIONS

This application claims priority to U.S. Provisional Patent Application Ser. No. 61/516,358, filed Apr. 1, 2011, and entitled Behavior-Based Online Deal Transactions.

This is application is a continuation-in-part of U.S. patent application Ser. No. 12/912,608, filed Oct. 26, 2010, and entitled Behavior-Based Data Configuration System and Method.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of electronic online shopping via a network, and, more particularly, to improving group shopping deals offered to buyers and request of sellers by buyers, and to generally improve computer applications related to online shopping.

### BACKGROUND

Among the most impacting technological progress in this century has been in the field of information technology, particularly in the area of online shopping, and even more particularly in the area of targeted marketing for online shoppers individually and in groups. In many applications, marketers make attempts to target certain audiences based on information gathered from user questionnaires, membership to certain websites or organizations of online users, and other sources. Generally, this intelligence is gathered and analyzed much like it was in the decades past, but is done so in the online context.

Existing applications attempt to market goods and services to users by targeting user consumers according to what the application marketing administrators envision is the most effective way to understand and target the average user. However, such methods fail to take into account the peculiarities of a given user, the constant change of user shopping preferences with time, subconscious elements of user preferences and buying habits, and myriad other unexpected factors that an administrator may overlook when configuring an application for targeting goods and services to consumers.

What are needed are new paradigms and approaches for applying target marketing approaches in computer and internet applications so that the application adapts to users based on the users' behavior in the application to bring relevant product deals to the users. This is particularly true in online shopping applications, and particularly where group approaches to buyers of services and products are addressed. Currently, static group buying includes fixed discount based approaches, such as local membership coupons for goods and services, or time based group approaches such as Priceline™ or holiday discounts such as Woot™ for example. These are targeted to local services such as restaurants, spas, etc., where high gross margins, discounted labor and time value and also the ability to cross-sell and up-sell make such approaches viable to providers. Dynamic group buying, such as personal and social friends based target marketing are limited to local services, where users can be attracted to the initial discount, but also open to be sold on other related products, up-sells, that normally go together with the service and are separately charged. For example, in the Groupon™ context, if a user buys a coupon online to visit a restaurant, the coupon can be used to discount the entrees, but a user and guests will likely accept up-sell services such as wine, desert, and other purchase items.

There are also fixed discount based approaches with a static membership, such as Costco™, Sam's Club™, MLM™, or Gilt Groupe™ for example, that are directed to global products. Unlike services, products are limited to low gross margins compared to services, are not adaptable to huge volume discounts (e.g. 50% or more), and have less opportunities for up-sell, since users typically purchase the product they are looking for without an physical environment like a restaurant or spa for cross-sell and upsell. Such products typically have such low margins already, that further big discounting results in breaking even on sales or even a loss, and repeat customers are less likely compared to restaurants and other services that can take advantage of high margins and repeat customers. Even if the big discount is not prohibitive for product selling, it is also difficult to form non-local groups or friend groups for goods that are targeted for national and international audiences since your local or Facebook friends are unlikely to want the same product such as a HDTV when you happen to be replacing your old TV.

In particular, within the framework of online shopping, where items may be purchased and paid for over networks such as the internet, more targeted marketing could be possible if user behavior could be better observed by merchants, and the resulting shopping experience for customers could become more meaningful and efficient. As will be demonstrated, the invention satisfies such unmet needs in an elegant manner.

### BRIEF DESCRIPTION OF THE DRAWINGS

FIG. 1 is a block diagram illustrating an example environment capable of implementing the systems and methods discussed herein.

FIG. 2 is a block diagram illustrating an example system of a client module and a behavior analysis module.

FIG. 3 is a block diagram illustrating various components of a behavior analysis module, which includes a communication module, a processor, and a memory.

FIG. 4 is a flow diagram illustrating an embodiment of a procedure for producing data element configurations in the behavior analysis module.

FIG. 5 is a flow diagram illustrating an embodiment of a procedure for obtaining a data element configuration in a client module.

FIG. 6 illustrates an example page in an application prior to reconfiguration of data elements.

FIG. 7 illustrates an example page in an application after reconfiguration of data elements.

FIG. 8 is a block diagram illustrating an example computing device.

FIG. 9 is a block diagram of the clustering of users and deals into interest groups.

FIG. 10 is a process flow diagram of a method for managing deals targeted to a prospect swarm.

FIG. 11 is a schematic diagram of an interface of a vendor website featuring a deal in accordance with an embodiment of the present invention.

FIG. 12 is a process flow diagram of a method for processing payment in connection with a deal in accordance with an embodiment of the present invention.

FIG. 13 is a process flow diagram of an alternative method for processing payment in connection with a deal in accordance with an embodiment of the present invention.

FIG. 14 is a process flow diagram of another alternative method for processing payment in connection with a deal in accordance with an embodiment of the present invention.

FIG. 15 is a schematic diagram of a system for gathering shopper information and generating deals in accordance with an embodiment of the present invention.

FIG. 16 is a process flow diagram of a method for incentivizing shopping activity in accordance with an embodiment of the present invention.

FIG. 17 is a process flow diagram of a method for generating lateral deals for a group of shoppers in accordance with an embodiment of the present invention.

FIG. 18 is a schematic diagram of an interface for managing deals in accordance with an embodiment of the present invention.

FIG. 19 is a schematic diagram of an interface for selecting user swarms in accordance with an embodiment of the present invention.

FIG. 20 is a schematic diagram of an interface for specifying automated deal generation parameters in accordance with an embodiment of the present invention.

FIG. 21 is a process flow diagram of a method for automatically generating deals according to deal generation parameters in accordance with an embodiment of the present invention.

FIG. 22 is a process flow diagram of a method for defining user swarm definitions in accordance with an embodiment of the present invention.

FIG. 23 is a process flow diagram of a method for obtaining user interest information using a manifest information gathering site in accordance with an embodiment of the present invention.

FIG. 24 is a process flow diagram of a method for correlating deals with web trends in accordance with an embodiment of the present invention.

FIG. 25 is a process flow diagram of a method for providing an enhanced deal for a “most-in-need” buyer in accordance with an embodiment of the present invention.

### DETAILED DESCRIPTION

Provided herein are new approaches to utilize user behavior information obtained from interactions of internet users for marketing purposes. These approaches are designed around the ability of a behavior observer to identify the online behavior activity of online users and predict the effectiveness of certain sales to them. These users may be targeted as individuals or may be pooled as a group for behavior analysis and targeted sales to the groups, where the groups are contextually formed among like minded groups, peers, social friends and other groupings. One approach might pool together like minded users who are shopping online for goods and/or services and to give merchants or service providers tools for directing shopping deals or discounts that are catered to particular groups or individuals.

In one embodiment, groups of users having common interests and intent to purchase can be pooled together and offered group deals. This alone improves the efficacy of one or more sales to individuals of the group, and also gives group members the benefit of deals or discounts specifically tailored to their interests, desires and intentions. Optionally, the group may be offered a deal that depends on a minimum number of members to commit to buy a particular product, increasing the odds of a larger sale to the group as a whole by stimulating the draw of the individuals to the group buying activity. This is also desirable by the group, who are drawn to an environment of concentrated deal offerings. This environment can also be quite expansive in many other aspects, including allowing cross selling and up selling to and among group members, allowing support groups to assemble among buyers of common goods or services, and generally build a peer group among users to enhance the market experience. Groups may be automatically formed and detected by the system based on user behaviors and other demographic or historical data known about users. In this way, users are automatically grouped into interest groups even though the users may not know one another or have any preexisting connection through explicit social networks or other means. These groups may be formed over long periods of time or be time bound. An interest graph may be created out of these interest groups wherein groups may overlap or be nested; visualizations and analysis of this interest graph may also be made available to merchants. Interest groups may also be analyzed for affinities or connections to specific products, terms, or user attributes. Based on these interest groups, the system may automatically determine the best deal to offer the identified group that will maximize any of a number of key metrics including conversion rate, revenue, margin, or other business criteria. This determination may be made in real time. The system may allow merchants to set rules on the type of products that may be offered or rules on the specifics of the deals. In this way the system is able to automatically identify interest groups and make offers to these groups that are not pre-determined or fixed in nature. Alternatively, the system may make recommendations for offers but require some approval workflow before going live. For example, the system may determine a rising interest in inexpensive red washing machines; classify current and previous users as members of that interest group based on their behaviors or user attributes correlated with other users already designated as part of the group; determine the ideal product to offer the group along with an optimized set of deal criteria including price, minimum and maximum deal size, and other offer attributes; and make the offer to the group through a website or any other means of communicating with users such as banner ads or email. The interest groups may be allowed to communicate with one another and may also persist after the offer is concluded, such as to provide group support or advice related the product or products purchased, including troubleshooting, tips, cross-sells, up-sells, or any other suggestions or information related to the interest of the group. Forums and other interfaces may be offered as a meeting place for interest groups to interact and share knowledge and experiences. The system also allows for interest groups to grow over time and be retargeted with other information and offers even after an offer is concluded. Users may also be identified as a part of multiple interest groups in which case the user may be “invited” into all relevant groups or the system may select and optimize which groups and offers the user is made part of.

In one example, merchants can offer deals to member users, individually or as a group, a market push to the member users, based on the interests and desires of the group members. Merchants can utilize behavior metrics based on behavior data gathered from group members to construct offers to the groups that are formulated to produce the best results. In offers as a group, a merchant can offer a group discount with certain requirements to ensure a profitable deal. For example, an offer can be made for a particular discount if a minimum number of products are purchased. There may also be a limit on the total number of products sold in the offering. There may also be a time limit, after which no products are sold if the minimum number of products is not sold, and/or where the offer expires even if the maximum number available is not sold. Other criteria may be added to the offer, including cross-sales, up-sells, geographical limitations, free shipping if within certain limits, limited number of products per user, margin and revenue requirements, requirements on users to follow up with comments, surveys, and referrals, in-store pickup or in-store presence for the offer to be valid, restrictions based on user reputation or status within the system or the merchant's system, and other criteria.

In a further extension of these novel features, users may request deals from the merchants to be provided to individual users or groups of users with like interests and intentions. In yet another extension of these novel features, requests for deals from the merchants to be provided to individual users or groups of users with like interests and intentions may be implicated based on actions. This facilitates a market pull from merchants to group members whether it occurs actively or passively, providing a mutual benefit between the interested buyers and sellers able to offer deals. In response, merchants can offer group or individual deals or discounts to individual users or groups according to group offering criteria that is favorable to the merchant, and that may further include offering criteria suggested by the users that originally requested the offering. The end result is a more collaborative and more predictable exchange between buyers and sellers that would more likely prove more beneficial than other exchange scenarios.

In still a further extension to these approaches, users may be automatically formed into interest groups based on the totality of their behaviors online and offline that can be tracked by the system and any other information known about the users. This automatic grouping may then be made visible to users for the purposes of communication or binding together to form buying groups or any other purpose where the automatic formation of groups with shared interest could provide value, such as enabling social interaction, cooperation, education, or political activism.

In still a further extension to these approaches, the framework and examples of an online mall is provided to allow merchants to target online customers based on behavior information gathered and accumulated from observance of online users.

The embodiments and examples provided herein can provide tools to be used by merchants to observe groups of users and to develop new approaches to online shopping that leverage data gathered around user behavior and interactions while shopping online to understand individual and group buying interests. In various embodiments, the described systems and methods can comprise gathering information about a finite set of data elements while a user interacts online while shopping or performing other tasks online, gathering information about user behavior amidst the interactions, and producing interest information of the individual user to be used in analyzing individual and group interests. The finite set of data elements may include particular key strokes, purchasing activities, product selection, search terms, links clicked, time spent interacting with products or related pages, as well as interaction with product descriptions, images, social media and other user forums related to products and interests, and other elements that indicate user behavior while shopping and otherwise interacting online. These elements may even extend offline as interactions with physical items become trackable through mobile barcode scanners or mobile cameras coupled with image processors and the like.

Also described herein are systems and methods configured to leverage gathered information to better target online shoppers and related users and entities to identify and correlate groups of users based on interests. Information gathered may include personal information, online search terms, links, words used in online shopping interactions and other activity, engagement with shopping websites and related groups, and other online or offline activity. Groups may be modeled based on gathered information and related data. Offers may then be made to these groups in a robust and targeted manner. Groups may be assembled based on the user data, and offers may be made to groups based on business rules including margins, inventories, up-sells, and other criteria.

Below are examples of the use of gathered information to improve a user's online shopping experience by providing contextual based analysis of data elements to merchants so they can be used to offer contextual based shopping deals to consumers. Other examples include the use of gathered information to group users together so that merchants can offer deals to different groups based on their group interests. In a further expansion of this concept, an internet mall of sorts may be configured to allow users to bargain as groups among different merchants to leverage the bargaining power of the various groups.

In the following description, numerous specific details are set forth in order to provide a thorough understanding of the invention. However, it will be apparent to one skilled in the art that the invention can be practiced without these specific details. In other instances, well known circuits, components, algorithms, and processes have not been shown in detail or have been illustrated in schematic or block diagram form in order not to obscure the invention in unnecessary detail. Additionally, for the most part, details concerning networks, interfaces, computing systems, and the like have been omitted inasmuch as such details are not considered necessary to obtain a complete understanding of the invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the claims, the terms “including” and “comprising” are used in an open-ended fashion, and thus should be interpreted to mean “including, but not limited to . . . .”

Embodiments and related implementation examples of the invention are described herein. Those of ordinary skill in the art will realize that the following detailed description of the invention is illustrative only and is not intended to be in any way limiting. Other embodiments of the invention will readily suggest themselves to such skilled persons having the benefit of this disclosure. Reference will be made in detail to implementations of the invention as illustrated in the accompanying drawings. In some instances, the same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

As used herein, the term “application” refers to any computer-based application or web-based application. Examples of web-based applications can be retailer websites, enterprise websites, information websites, social websites, and any other websites online sales can occur either directly or indirectly. Examples of computer-based applications can include dedicated applications for merchants to generate and offer shopping deals to customers, social network applications that attract and manage groups of users in connection with online shopping deals, group memberships in social networking activities, in-store kiosks or mobile applications that may be location-aware and capable of interfacing with in-store products and artifacts, in-car interfaces such as navigation systems, or other computer programs or applications. There also may be a combination of web-based applications and computer applications in a distributed system, where merchants, users or groups of users may have local applications that perform the operations disclosed herein within a sort of shopping ecosystem. Those skilled in the art will appreciate that such systems can take on many forms within the spirit and scope of the invention given this disclosure.

As used herein, the terminology “relevant content” or “relevant information” refers to content that is predicted to produce a desirable result for the user, for the host of an application, or for another party when the “relevant content” is used to generate a benefit to the user, such as to offer purchasing deals to users. For example, relevant content may include content related to the interests of a user or group of users categorized according to interests. Relevant content can be a link to a product that a user or group seeks. Alternatively, relevant content can be a link to a product that the user or group does not seek but where offering deals to products related to interests of an individual or group is predicted to benefit the host of the application, for example, by motivating the user or group to buy a product from the host merchant.

In such cases, various routines can be used to periodically offer shopping deals to groups in order to determine whether user tendencies of a particular group or groups towards such or similar products have changed and/or whether those products should become part of succeeding deals offered to groups. Those skilled in the art will recognize the above as a time-, user-, and context-dependent multi-armed bandit problem requiring a “bandit strategy” that balances between exploitation of information already learned and exploration of new options or deals offered to individuals or groups or changing efficacy of existing options.

The actual makeup of a group may take many forms. In one example, groups may be established by membership, where members are invited or otherwise enticed to sign up and join the group. Members may receive special benefits based on their status in the group, whether the benefits are exclusive deals, special discounts on certain goods, or other benefits. The status may relate to their tenure in the group, interactivity with other members in the group, generosity in time spent administering the group, purchase history, activity in requesting deals form merchants, or other activities beneficial to the group and deemed worthy of special status.

Alternatively, groups may be formed in the background of an application, where users are categorized according to their interests, desires, intentions or other characteristics based on behavior information gathered in response to their online interactions and other information. The groups may be formed dynamically based on a user's ongoing online interactions and other updated information, and may be grouped in a background application that tracks user activity and evolving interests, desires, intentions, and other characteristics.

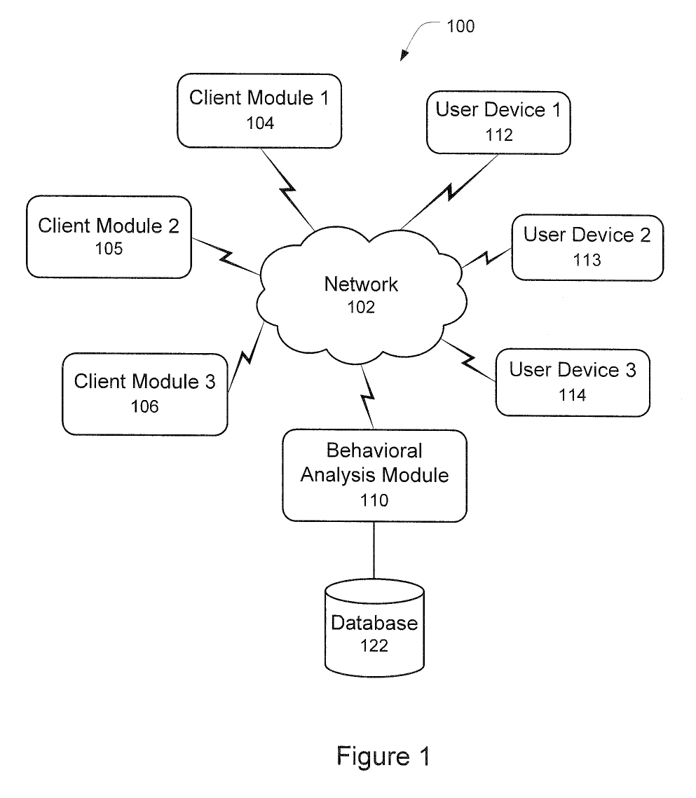

FIG. 1 is a block diagram illustrating an example environment 100 capable of implementing the systems and methods discussed herein. A data communication network 102, such as the Internet, communicates data among a variety of devices, including client modules, user devices, behavioral analysis modules, and so forth. Data communication network 102 may be a combination of two or more networks communicating data using various communication protocols and any communication medium.

The embodiment of FIG. 1 includes client modules 104, 105, and 106, which represent one or more locations that either have access to website enabled applications or local applications for generating shopping deals for individuals and/or groups according to various configurations. These offers may be made simultaneously, posted on a website or message board, and they may be secured or unsecured but available for use by members only. Offers may also be made asynchronously such as through later communications in a banner ad, email, text message, chat, or other means of communicating with users. Client modules 104, 105, and 106 may be web servers, enterprise systems, personal computers, and any other systems that can access websites for offering shopping deals. At these client modules, merchants for example may offer shopping deals to groups or individuals based on group and/or individual behavior analysis. Environment 100 also includes behavior analysis module 110, which can receive data associated with user behavior and data associated with a finite set of data elements and distribute data element configurations to client modules 104, 105, and 106, and other content sources through the network 102. These data elements may relate to behavior information related to individual or group interest in products for sale on line, whether they are delivered online or via separate product delivery, such as mail delivery, package shipping, etc. Client modules 104, 105, and 106 can be accessed by multiple user devices (e.g., user devices 112, 113, and 114 shown in FIG. 1), which are seeking specific content related to online shopping and other related transactions.

In one embodiment, a client module may be configured in conjunction with a social networking website or a dedicated group activity module that either operates independently as its own network or as an application or other entity within a larger social network. Whichever configuration, the module may communicate with the social network website members for gathering behavior information based on user member interactions within the social network. The behavior information may be related to actual online shopping tasks, key strokes, searches performed, links clicked, pages visited, on-page elements interacted with, blogging, purchasing, delivery preferences, interaction with other members of a group or social network, authoring or review of articles or comments in connection with the group or social network, or other activity.

The client modules may also be merchant websites that gather behavior information from shoppers that sign up memberships with the particular merchant website. Alternatively, the merchant website may have a cooperative communication link with a social network that authorizes the merchant website to communicate with members of the social network to offer shopping deals to individual users and/or groups.

A user can search or browse through content on applications on the client modules 104, 105, and 106. In various embodiments, users can also access applications directly on the client modules 104, 105, and 106. The behavior of the users on the applications or websites with respect to a finite set of data elements in the application can be observed on the client modules 104, 105, and 106 and the behavior observations can be conveyed to the behavioral analysis module 110. The behavior observations can be analyzed in the behavioral analysis module 110 and a configuration of the finite set of data elements can be produced to improve targeted marketing to users as consumers. Here, users may be the shoppers or group members, and the client modules may be used by merchants targeting group users. Thus, the data elements may be defined as the points of interaction of the users within websites and possibly applications that communicate with the behavior analysis module. The resulting behavior analysis information based on the interaction of the users with the finite set of data elements can be conveyed from the behavior analysis module 110 to client modules 104, 105, and 106 over the network 102. This may include information related to the interaction of the users while shopping online or otherwise interacting at client websites or applications that produce user data that can be used to configure shopping deals and discount offers to users and/or groups that are predicted for successful sales. The client modules 104, 105, and 106 can arrange content in applications according to the conveyed user data to offer these deals. In various embodiments, client modules 104, 105, and 106 can request configurations of the finite set of data elements from the behavior analysis module 110. In other embodiments, client modules 104, 105, and 106 can receive configurations of the finite set of data elements from the behavior analysis module 110 on a periodic basis, or alternatively in real time.

Data associated with user behavior that is conveyed to the behavior analysis module 110 can comprise any user actions that can be observed in a user's interaction online or in using applications on the client modules or websites associated with the client modules. Depending on the type of data element, user behaviors can include interaction with the data element or lack of interaction with an available data element, including repeated interactions and time-profiles of such repeated behaviors; selection of a data element or sub-element such as clicking or otherwise choosing a menu option or radio button, starting or pausing a video; information entered into a data element, such as a search query or free text comment; movement of the data element, such as drag and drop; highlighting, copying, and pasting of data elements; changing the appearance of data elements, such as hiding, minimizing, maximizing; starting and completing online purchases and all interactions involved in such activity; and other activity that may be observed and recorded. Interaction with data elements may also lead to the presentation of content or further data elements with which the user may also interact. User behavior on subsequent content and data elements may also be associated with the parent data element or elements. For example, selection of a particular data element may eventually lead to purchase of an item or usage of content. This behavior may impact subsequent configuration of the initial data element selected and may be used to configure different merchant offers to individuals or groups. For content or large data elements, user behavior may also include time spent interacting with the object, the number and frequency of interaction, amount of the element seen, and any interactions with sub-elements or sub-content.

Numerous methods are available and well known in the art for collecting behavior data in applications and will not be covered here in detail as such details are not considered necessary for a complete understanding of the invention.

Data associated with the finite set of data elements that is conveyed to the behavior analysis module 110 can comprise, for example, any metadata associated with the data element, such as type of element as well as details regarding sub-elements and possible interactions a user may have with the element; details regarding the presentation of the element, including location, size, color, look-and feel, configuration, or other state information; groupings of data elements, including visual groupings or logical groupings and dependencies.

The data associated with user behavior can be analyzed to produce a configuration of group offers using various methods of content delivery optimization. For example, a variety of machine learning techniques such as reinforcement learning, Bayesian networks, neural networks, and genetic algorithms may be used to efficiently explore and exploit the space of configurations on a global, per-segment, per-user, or per-context basis. Other methods may be used to predict optimal deal offers based on user behaviors or other attributes, such as personalization and collaborative filtering techniques and variants thereof. Information retrieval, text-processing, and natural language processing techniques may also be employed to predict optimal configurations when the data elements include, effect, or lead to textual or verbal content or metadata. All of the above techniques may be used to predict optimal shopping deals to be presented to users and groups, as well as interpret and learn from user behaviors on elements.

In addition to user behaviors associated with a purchase deal related data elements and their configuration, additional information about users may be gathered to predict optimal deal offer configurations and organize learning related to specific elements and configurations. For example, demographic data or survey data may be collected on users and incorporated into the models. Offline behaviors such as purchase histories or location data may also be included. Online behaviors prior and subsequent to interaction with data elements may also be included.

Internal application behaviors including interaction with data elements may be observed through APIs called by an application or website portal depending on the configuration. On a website, this may be a JavaScript or image-based tag placed into the header or footer of the website. Logfiles may also be uploaded to provide more data for behavior analysis. Additionally, offline or other behaviors outside of the application may be uploaded through logfiles or other data transfer methods.

The information collected by the system, including user behaviors or other uploaded data may be analyzed and modeled using a variety of methods to predict the optimal configuration of purchase deals related data elements for a given user or group of users in a particular context.

Most any type of data element that has multiple possible configurations and the potential for user interaction with the element may be observed by the system and interactions by a user can prompt the generation and storage of interaction information for use in behavior analysis. The data element may be a feature or term of a purchase deal being offered, or items on a website being arranged for the convenience of a user. The example to follow focuses on data elements on website that can be arranged or otherwise manipulated based on contextual information from user information and/or activity online, with an application, or other entity where a user interacts. User interface elements may be configured by the system including menu items, radio buttons, selection boxes, lists, and hyperlinks. The position and appearance of data elements within the user interface may also be configured using the behavior information. The interaction with these elements provides valuable behavior information for the system to use to predict optimum deal offers by merchants to send to potential purchasers of goods individually or within a group.

In one example of a system configured for behavior analysis and deal offer optimization, a communication first occurs between the application or website and the system. In this communication, the application sends available information about the user, context, and available data elements to the system. The system may then suggest an optimal or set of optimal configuration of those elements to generate a shopping offer given all available data. The application then configures the data elements of the purchase deal based on this suggestion and provides the generated purchase deal to the user. A default configuration may also be determined as a fallback strategy if for any reason the system is not reachable or has no data with which to make a suggestion. This communication may occur in real time, but it may also occur in a batch or otherwise offline mode.

The application may make information available to the system outside of the client module. This may include any information about the application or users that the application or application owner has access to. The system may also aggregate information from multiple applications or websites. It may also gather information through other means, such as through experts or crawling and gathering of online data, to inform the models.

In one embodiment of the invention, traditional HTML is augmented to enable dynamic configuration and adaptation of user interface elements on a website. This can be achieved with minimal additional effort by the web author. For example, the below HTML element is a standard method for creating menu items:

<ul id=“nav-menu”>

<li id=“nav1”><a href=URL1>Nav1</a></li>
<li id=“nav2”><a href=URL2>Nav2</a></li>
<li id=“nav3”><a href=URL3>Nav3</a></li>
<li id=“nav4”><a href=URL4>Nav4</a></li>

</ul>

With the inclusion of a single JavaScript file and minimal instrumentation of the HTML element, as indicated below, the menu item can now be made adaptive, such that it configures itself optimally based on the user and context.

<script src=″ahtml.js″></script>
<ul id=″nav-menu″ class=”ahtml”>

<li id=″nav1″><a href=URL1>Nav1</a></li>
<li id=″nav2″><a href=URL2>Nav2</a></li>
<li id=″nav3″><a href=URL3>Nav3</a></li>
<li id=″nav4″><a href=URL4>Nav4</a></li>

</ul>

The JavaScript file includes the logic for observing user behavior with the data elements as well as all other behaviors on the website or known to the website. The JavaScript file may be hosted locally or remotely. The JavaScript file also includes the logic for contacting the system to retrieve an optimal configuration of the menu given the user and context. In one embodiment, the JavaScript file will hide the instrumented menu list, contact the system, reorder menu items and then unhide and display the optimized order. If the system is unreachable for any reason, the existing menu list will be unhidden and displayed with the default order. Any HTML element including radio buttons, dropdowns or divs may be easily adapted in this way. For example, a user who has been to the website five times, lives in New York and arrived at the site from a search on “flights to Las Vegas” may see a different ordering of menu items then a user who is on the site for the first time and has interacted with two pages within the site that are related to sunny beaches. With minimal involvement from the website author, an entire website and user experience can become adaptive to user needs and contexts in real time.

A database 122 is coupled to communicate with behavior analysis module 110, as shown in FIG. 1. Database 122 stores various data and/or information related to application or website content, purchasing information on users or groups of users, data elements, user behavior on applications or websites, data element configurations, and related data. Information from client modules 104, 105, and 106 regarding data associated with user behavior and data associated with data elements can be stored in database 122.

Although environment 100 illustrates three client modules 104, 105, and 106; one behavioral analysis module, 110; and three user devices 112, 113, and 114, particular environments may include any number of client modules, behavioral modules, user devices, and other devices. Also, although behavior analysis module 110; client modules 104, 105, and 106; user devices 112, 113, and 114; and database 122 are shown in FIG. 1 as separate components, in particular implementations, any two or more of these components can be combined into a single device or system.

Various APIs (application programming interfaces) may be used to communicate data between the components and systems shown in FIG. 1. For example, APIs exist between behavioral analysis module 110 and client modules 104, 105, and 106. Other APIs exist between client modules 104, 105, and 106 and user devices 112, 113, and 114. In particular embodiments, these APIs are HTTP (Hypertext Transfer Protocol) Request/Response systems. In specific implementations, behavioral analysis module 110 communicates with client modules 104, 105, and 106 using JavaScript (with HTTP requests/responses) via AJAX (asynchronous JavaScript and XML) within a browser.

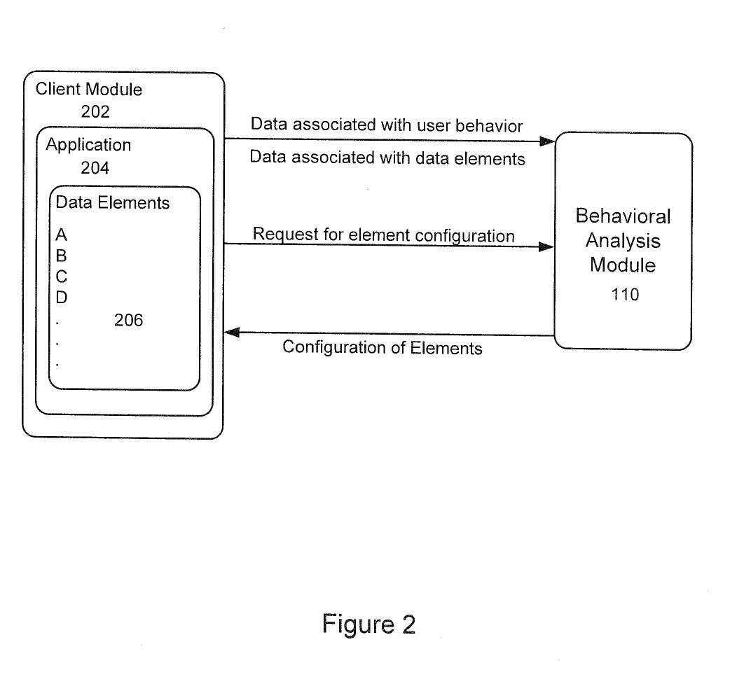

FIG. 2 is a block diagram illustrating an example system of a client module 202 and a behavior analysis module 110. The client module 202 can be any system hosting an application 204. The client module 202 can be a module such as the client modules 104, 105, and 106 illustrated in FIG. 1. For example, the client module 202 can be an enterprise, a computer, or a network of computers. The application 204 can be a computer program or a website. A finite set of data elements 206 can be contained in the application 204. As described above, the data elements can be various options, menu items, user commands, links, or other visual objects that a user or group of users interacts with to produce behavior data. Data associated with user behavior in the application 204 and data associated with data elements 206 can be conveyed to the behavior analysis module 110. A request for a configuration of data elements can be conveyed to the behavior analysis module 110. The behavior analysis module 110 can analyze the data associated with user behavior and the data associated with the set of data elements and convey a configuration of elements to the client module 202. The client module can configure the data elements according to the configuration received from the behavior analysis module 110 to produce optimum deal offers to users and groups.

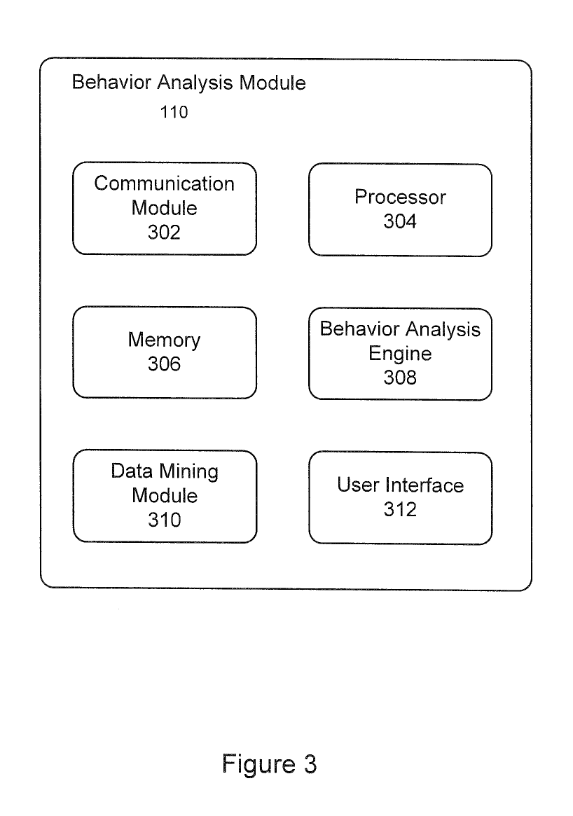

FIG. 3 is a block diagram illustrating various components of a behavior analysis module 110, which includes a communication module 302, a processor 304, and a memory 306. Communication module 302 allows behavior analysis module 110 to communicate with other devices and systems, such as client modules 104, 105, and 106 shown in FIG. 1. Processor 304 executes various instructions to implement the functionality provided by behavior analysis module 110. Memory 306 stores these instructions as well as other data used by processor 304 and other modules contained in behavior analysis module 110.

The behavior analysis module 110 also includes a behavior analysis engine 308, which analyzes available data associated with data elements and user behavior to produce data element configurations for offering shopping deals to users and/or groups. The behavior analysis module 110 also includes a data mining module 310, which searches for data through knowledge bases, such as knowledge bases, such as the database 122 in FIG. 1 and retrieves data, such as data about user behavior and data element configurations. A user interface 312 allows administrators, web developers, and other users to interact with the various components of the behavior analysis module 110.

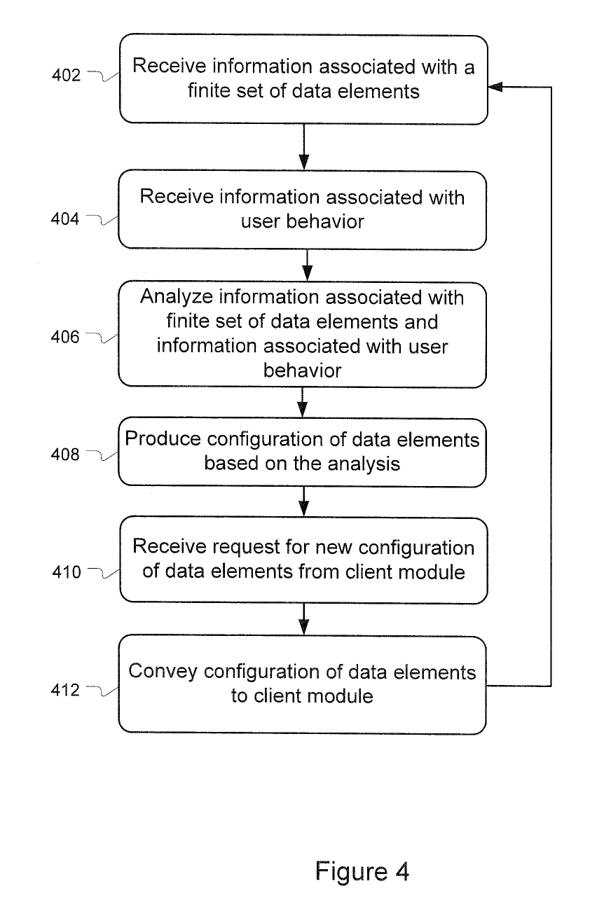

FIG. 4 is a flow diagram illustrating an embodiment of a procedure for producing data element configurations for use in configuring deal offers to users and groups in conjunction with the behavior analysis module 110. As illustrated in the example of FIG. 4, information associated with a finite set of data elements is received 402. Information associated with the behavior of users is received 404. The information associated with a finite set of data elements and the information associated with the behavior of users is analyzed 406. A configuration of data elements for a deal offer to users or groups is produced based on the analysis 408. The behavior analysis module receives a request for a configuration of data elements from a client module 410. The produced configuration of the data elements is then conveyed to the client module 412. The data elements in the client module can be reconfigured according to the new configuration to improve the efficacy of deal offerings. Information associated with a finite set of data elements, where the data elements are in the new configuration, can be received 402.

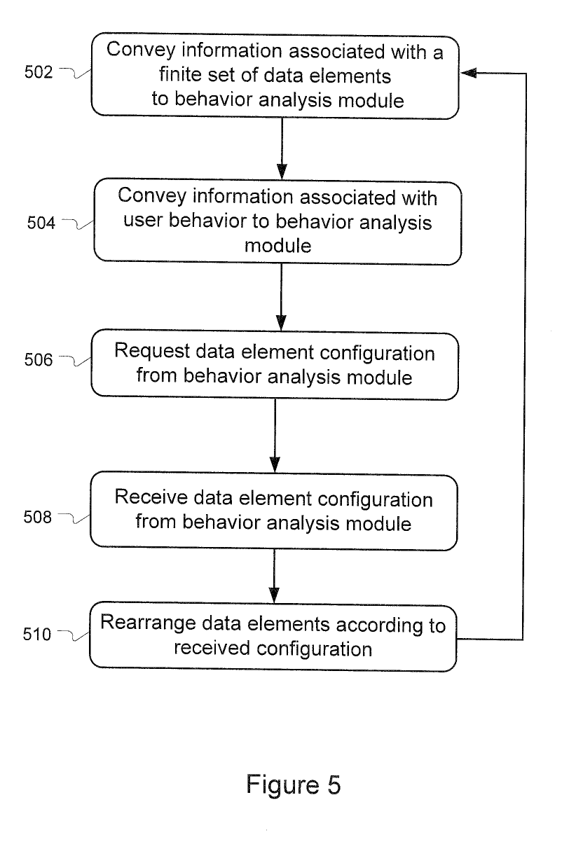

FIG. 5 is a flow diagram illustrating an embodiment of a procedure for obtaining a data element configuration associated with a deal offering in a client module. As illustrated in the example of FIG. 5, information associated with a finite set of data elements is conveyed to the behavior analysis module 502. Information associated with the behavior of users is also conveyed to the behavior analysis module 504. A configuration of data elements based on the information associated with a finite set of data elements and the information associated with the behavior of users is requested from the behavior analysis module 506. A configuration of data elements is then received from the behavior analysis module 508. The data elements in the application or website associated with deal offerings can be configured according to the received configuration 510. Information associated with a finite set of data elements, where the data elements are in the new configuration, can be conveyed to the behavior analysis module 502.

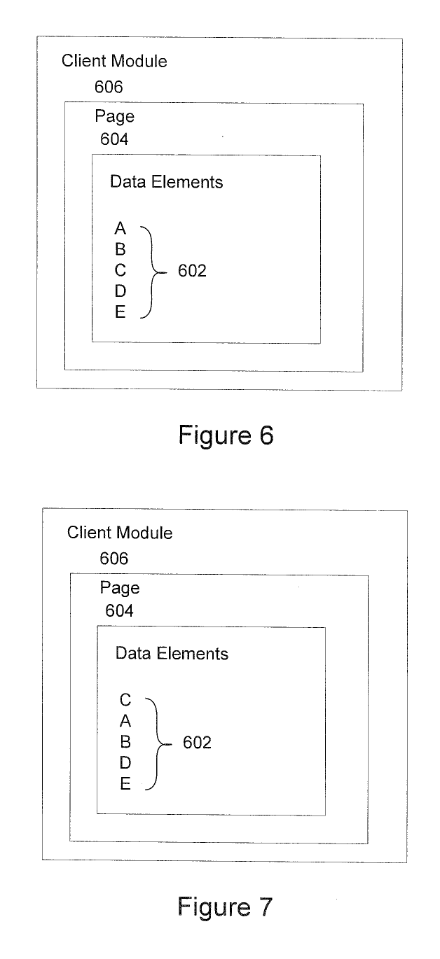

FIG. 6 illustrates an example page in an application prior to reconfiguration of data elements that relate to deal offerings. As illustrated in the example, a set of data elements 602 can be displayed in a page 604 of an application within a client module 606, where the data elements may be parameters of a deal offering, such as for example particular offer criteria related to a particular shopping deal offering to a user or group of users. User behavior with respect to the data elements is observed and the behavioral data is stored. As described above, such observations can correspond to what proportion of users selected a particular data element or what proportion of users selected a particular data element and made a subsequent purchase. Data associated with the observed behavior and data associated with the current configuration of the data elements is conveyed to a behavior analysis module. In the behavior analysis module, a configuration of data elements that enhances the efficacy or effectiveness of a particular deal offering to a user or group of users can be produced. The produced configuration is conveyed to the client module. In the client module, the data elements are reconfigured according to the conveyed configuration for use in a deal offering.

FIG. 7 illustrates an example page in an application after reconfiguration of data elements. As illustrated, the data elements 602 in FIG. 6 are reconfigured, resulting in the configuration of data elements 602 illustrated in FIG. 7. The configuration in FIG. 7 can correspond to the conveyed configuration from the behavior analysis module. For example, in the behavior analysis module, it can be observed that more purchases are made by users who select element “C” than any other element. Based on that observation, the behavior analysis module may produce a configuration placing element “C” at the top of the list to improve user access to element C. Such a configuration can be communicated to the client module, which client module can implement the conveyed recommendation as illustrated in FIG. 7. Though this is illustrated as an example of rearrangement of visual items to a user, configurations of deal offerings with variables in offer parameters can also be illustrated.

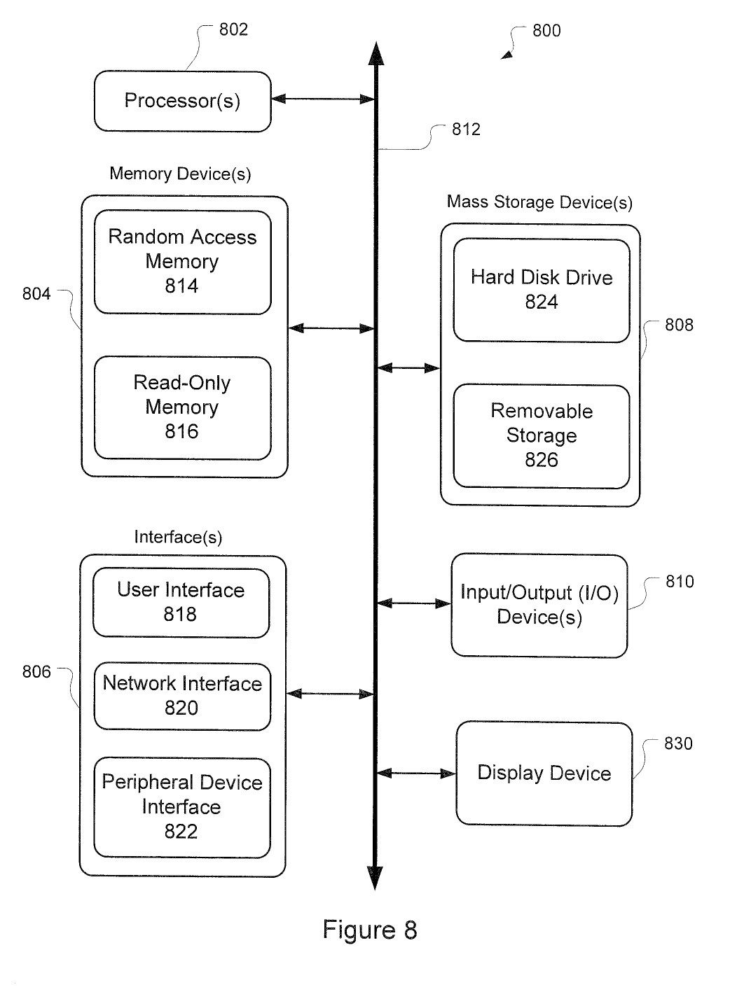

FIG. 8 is a block diagram illustrating an example computing device 800. Computing device 800 may be used to perform various procedures, such as those discussed herein. Computing device 800 can function as a server, a client, a user device, or any other computing entity. Computing device 800 can be any of a wide variety of computing devices, such as a desktop computer, a notebook computer, a server computer, a handheld computer, and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM)) 814 and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid state memory (e.g., Flash memory), and so forth. One type of mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interfaces include user interface 818 and peripheral device interface 822.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

An extension of this concept is provided as an embodiment configured to provide new shopping experiences online, where groups are identified and targeted based on their interests, overall online behavior, interactions, and other activity. As discussed in the background, there are challenges to offering group discounts on products as opposed to services. One is that products have low margins that make large discounts often seen in group discount offerings prohibitive. Also, unlike group discounts offered to services that are by their nature a local offering, it is difficult to form non-local groups in social scenarios where portable products are offered. Also, unlike services, up-sells are not practical for products, where optional related products are not always necessary for buyers of products. To address these challenges, embodiments of the invention are provided to overcome these barriers.

In one example, to overcome the low margin differences typically seen in products, high margin products are targeted, such as apparel, clearance products, brand manufactures, etc. To address the challenge to up-sells, novel approaches to offering group discounts for products can take on many different characteristics, including offering multiple offers per day, teaming up with manufacturers for advertising purposes, and offering a group discount for a minimum number of products to be purchased in a group—for example, offering a discount if no less than 10 items are purchased in a particular offering, ensuring a minimum number of products sold in an offering. Game psychology is also employed to attract and engage users to participate in purchasing opportunities.

In one example, a computer-implemented method may include receiving data related to interests associated with online behaviors of multiple users, modeling groups of users based on their interest information, determining potential purchase interests of modeled groups of users, and targeting product offers to the modeled groups. Thus, the groups would have a contextual interest base, and merchants will have a more predictable basis for offering group deals on products based on the contextual knowledge of the group. The group or club may also be considered a dynamic product category emerged from the users.

Groups may be identified by information gathered based on their general information and online behavior data and information, including previous user information, contact terms, search terms and phrases used when looking for products. The groups may be assembled and organized by a central group organizer, or may invite users to join the groups by enticing them with the prospect of good deals on products. Once established, group behavior information may continually be gathered by a behavior analysis module to better define the interests of the group based on the individual and collective behavior data of the group members.

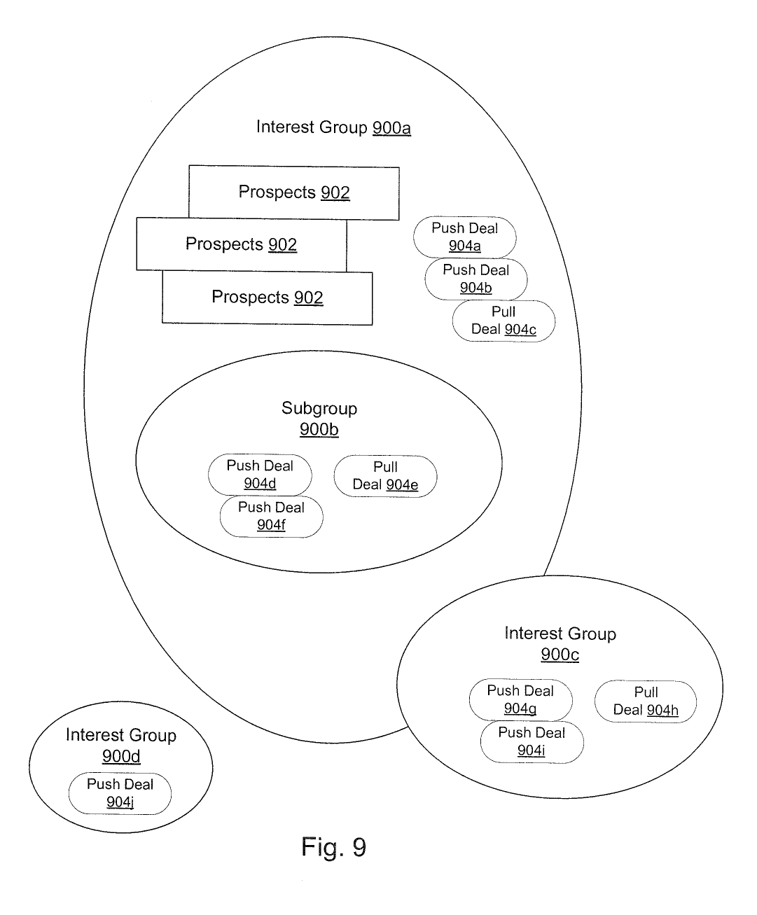

FIG. 9 illustrates a conceptual example of a few groups in the form of a VEN diagram, where one group 900a of prospects 902a-902c is assembled based on interests in televisions. The TV club or group, includes a subgroup 900b of individuals with specific interests in 3D LED televisions. The TV group 900a is based on user information and online shopping behavior, for example identifying users who have already bought certain televisions, identified as buyers, and those who have interests in televisions but have not bought yet, identified as prospects. Prospects 902a-902c may become buyers once they participate in a group offering. In one example, a prospect 902a-902c or other member that first participates in a deal may get a further discount, other participants may get a scaled discount depending on the timing of which they join the deal offering, encouraging early participation in a deal by group members.

Push and pull deals 904a-904c may be offered to the group, and specific deals 904d-904f may be offered to subgroups 900b, such as the 3D LED television group for example. Other related groups may have overlap with a particular group, such as the Blue Ray DVD play group 900c shown, where push and pull deals 904g-904i may be offered to group members, and the overlap may be utilized by merchants to offer deals to related groups. Unrelated groups, such as the sandal group 900d shown, may have no overlap and thus no cross-over value to a merchant offering group deals 904j. Thus, the collective information gathered by contextual analysis of individual and group behavior may be utilized to provide a powerful tool to merchants and other sellers who want to provide group deal offerings with more effective and predictable target marketing.

Sellers may then target members of groups by offering special product deals, known as a market push, proactively sending members deal offerings. In this context, merchants may offer clearance priced products, products offered as loss leaders to attract group members to other products, and other offerings based on the groups' collective interests, providing a merchant with a valuable target marketing tool for offering goods to users based on their interests.

Group members may also be prompted to seek out explicitly or implicitly certain products based on the group interests, providing a market pull for products by the group. In one example, group members create “pull” deals, offerings to merchants from group members who would like a deal on a particular product. In such a case, a group member can propose to merchants a pull deal for a particular product, a price range the user is willing to pay or a discount that the group may be interested in, other details on the deal offering, and the deal may then be offered to merchants, whether they are associated with the group or not, and the merchants are then open to offer deals within the pull offering parameters.

In one example, a deal management website may be configured to attract and receive group members based on membership associations, and the deal management website may communicate with a behavior analysis module to gather and analyze the online behavior of users to determine interests of the group members in certain products. In one example, an interest factor computed according to an interest algorithm is used by a merchant to gauge interests of a groups members in particular products. A merchant may use that interest factor to determine which groups may be interested in particular products, and may also be used by the merchants to structure the group deal. A properly configured user interface, psychology and game-playing tendencies of group members provide a mechanism for sellers or merchants to entice and attract buyers.

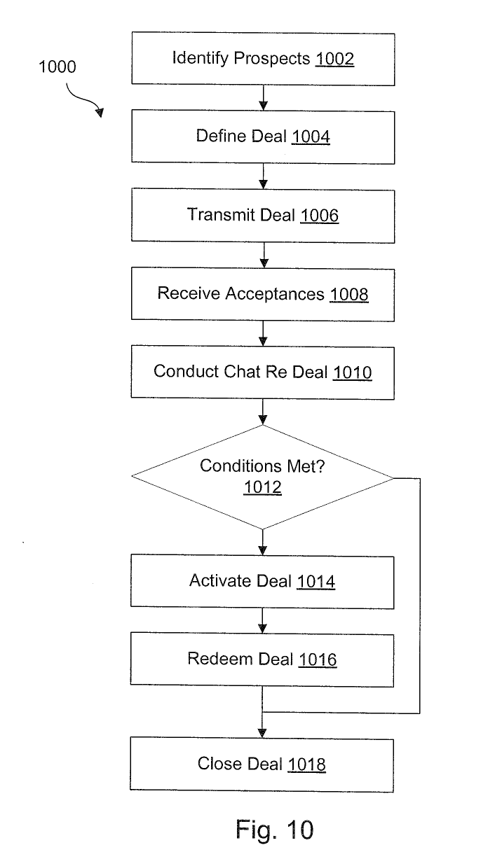

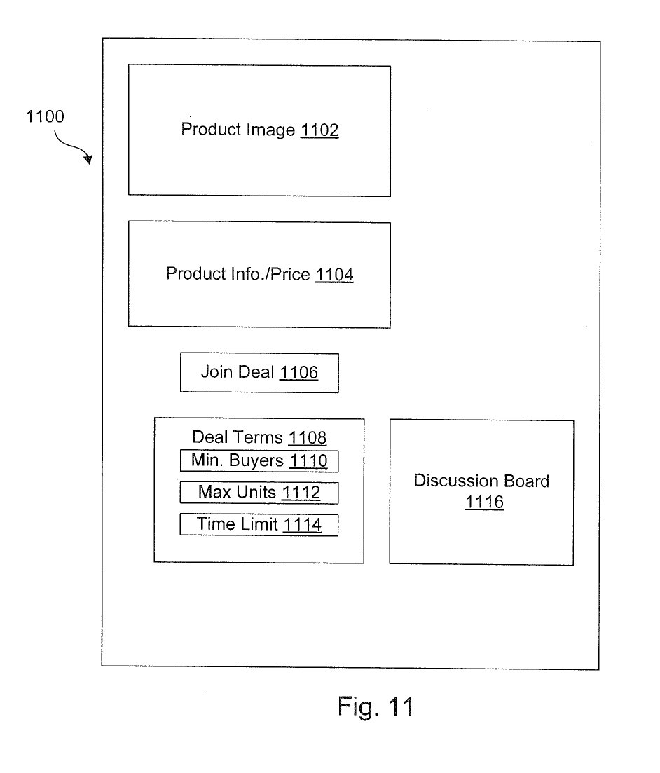

FIG. 10 illustrates a method 1000 for generating deals. The method 1000 includes identifying 1002 prospects. This may include any and all of the behavioral analysis methods described herein using any and all of the methods described herein for gathering information regarding consumer behavior by monitoring internet usage and behavior and any other online and offline methods for gathering information regarding consumer preferences and behaviors.

A deal is then defined 1004 for a group identified 1002 as prospects with common interests. The deal may therefore include a product that would seem to be of interest to the prospects during the identification step 1002. In some embodiments, other parameters of the deal may be chosen according to the identification step 1002. For example, knowledge of the income may be used to choose a product of interest that is likely to be priced appropriately. Multiple other parameters such as geographic location, gender, age, and other demographics may also be used.

The deal may then be transmitted 1006 to the prospects. This may include displaying a link on a website of a vendor or the provider of deal management services. The deal may be presented as a pop-up based on real time analysis of a prospects current viewing of a web page for a product within the identified 1002 interest group. Transmitting 1006 the deal may include displaying as sponsored advertisements, sending emails, making posting on social networking sites, and like means of advertisement and promotion. In an alternative embodiment, a deal may be a “pull deal” that is received from a prospect and forwarded to a vendor, such as by a deal management system. A pull deal may be joined or endorsed by other users. This may be facilitated by a web site hosted by a vendor or deal management system or through a social networking site or email. The pull deal and any endorsements or information regarding joining users may be transmitted, such as by the deal management system, to the vendor for approval. If approved the deal may be transmitted 1006 to prospects such as those who have joined or endorsed the pull deal, or others that are identified as prospects according to methods described herein.

Acceptances of the deal may then be received 1008. A deal may be accepted by registering, or logging in as an established user, with the entity providing the deal or an authorized representative. Acceptance may also include providing payment information and authorization or authorizing use of previously provided payment information in the event that a deal is activated.

In some embodiments one or more of a vendor, prospective buyer, and a provider of deal management services may also conduct chat 1010 with respect to a deal. As known in the art this may include receiving postings and transmitting them for display in the context of an accessible website or messaging application.

If the conditions of the deal are found 1012 to be met then the deal is activated 1014 meaning that those from whom acceptance has been received 1008 may be allowed to proceed with purchase under terms of the deal. The deal may then be redeemed 1016 by the users. Redemption 1016 may be performed automatically using previously stored payment information or information provided with the acceptance. Redemption may include providing the product or service that was the subject of the deal. Notice may be transmitted to the accepting user in connection with redemption. Notice may also be sent to a vendor along with remittance of payment as part of redemption. Following redemption 1016 or if conditions of the deal are not found 1012 to be met, the deal may then be closed 1018.

FIG. 11 illustrates an example interface 1100 in which methods described herein may be practiced. Functionality described below as being invoked by the interface may be provided by one or a combination of two or more of a user device, a server hosted by a vendor, and a server hosted by a provider of deal management services. The interface 1100 may be provided by a vendor of a product or a provider of deal management systems. The interface 1100 may include one or more of a product image 1102 and product information and price 1104. In instances where the viewer of the interface has been identified as a likely prospect as described herein, an interface element 1106 may be included inviting a prospective buyer to join a deal as described herein. The element 1106 may be a link, button, or other interface element that invokes acceptance of deal as described above. Deal terms 1108 may also be displayed, either un-solicited or in response to a user interacting with the interface element 1106. As for the interface element 1106, the deal terms 1108 may be displayed only where the user to which the interface 1100 is presented is found to be a likely prospect according to behavioral analysis as described herein. In some embodiments, the deal terms 1108 may be displayed upon user interaction with the element 1106.

The deal terms presented may include, for example and without limitation, a minimum number 1110 of buyers before the deal is activated, a maximum number of units 1112 that can be sold under the deal, and a time limit 1114 or date before which the deal must be activated before it is closed. A discussion board 1116 in which prospective buyers (as identified as disclosed herein) may comment on the deal and the product that is the subject of a deal, or any other aspect of a potential transaction. Postings may be input through the interface 1100 and the interface updated to display postings by the entity hosting the site.

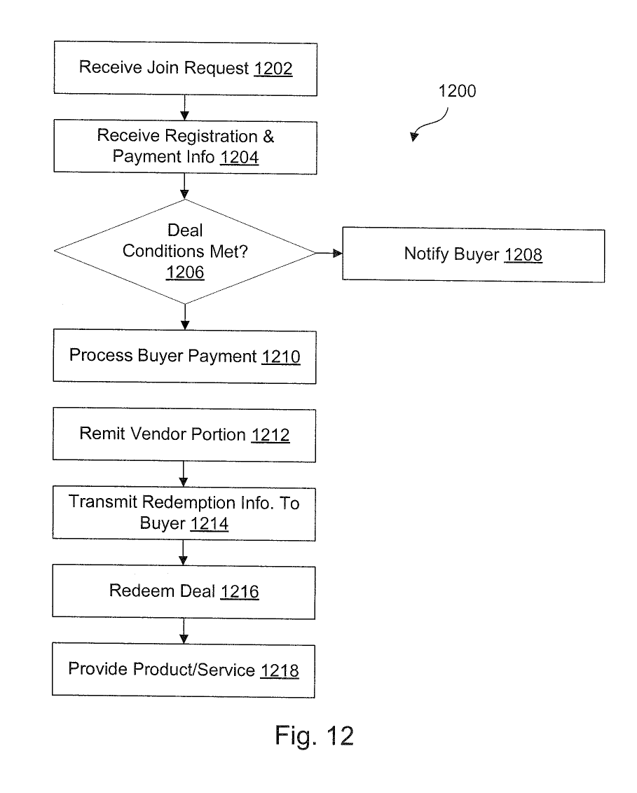

FIG. 12 illustrates a method 1200 for managing acceptance and redemption of deals. The method 1200 may occur following creation and of a deal and transmission of the deal to prospects. The method 1200 may be performed by one or a combination of a server hosted by a provider of deal management services and a vendor who will fulfill the deal. The method may include receiving 1202 a request to join a deal and receiving and/or retrieving 1204 registration information and/or payment information. Those requesting to join are referred to herein as buyers. If the conditions of the deal if subsequently or currently found 1206 not to be met according to terms of a deal as described herein, buyers may be notified 1208 of this and the method ends.

If the conditions of the deal are found 1206 to be met, then payment is processed 1210 for each buyer using the information received or retrieved 1204. The provider of deal management services may remit 1212 a portion of the payment received to a vendor. Redemption information may also be transmitted 1214 to buyers indicating that the deal was successful. The deal may then be redeemed 1216 upon provision of redemption information (e.g. a redemption code) by the buyer to the vendor. And the product or service that was the subject of the deal may be provided (e.g. shipped) to the buyers. In some embodiments, redemption 1216 is invoked by a deal management server without involvement of user upon finding 1206 the conditions of the deal to be met, in which case transmission 1214 of redemption information is not helpful.

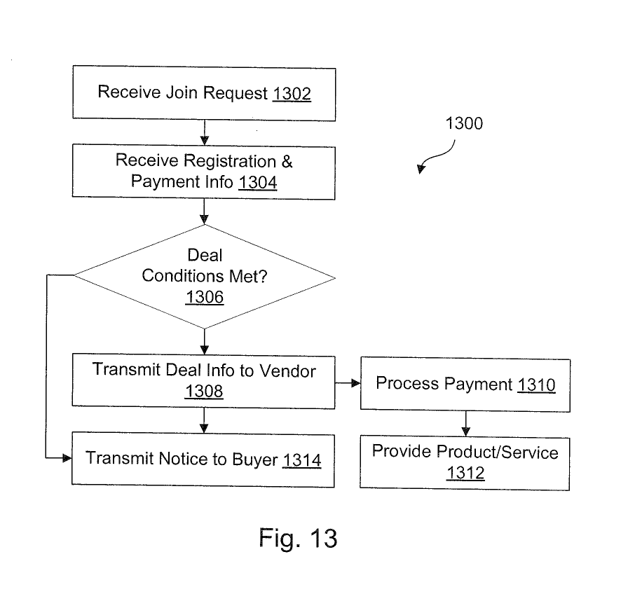

FIG. 13 illustrates an alternative method 1300 for managing acceptance and redemption of deals. The method 1300 may occur following creation and of a deal and transmission of the deal to prospects. The method 1300 may be performed by one of or a combination of a server hosted by a provider of deal management services and a vendor who will fulfill the deal. The method may include receiving 1302 a request to join a deal and receiving and/or retrieving 1304 registration information and/or payment information.

If the conditions of the deal are found 1306 to be met, then information regarding the deal, including payment information, is transmitted 1308 by the provider of deal management services to a payment processor, such as a point of sale (POS) convergence or the vendor offering the deal. The payment processor then processes 1310 the payment using the payment information by the buyer and the vendor provides 1312 the product or services that is the subject of the deal. In either case, if the deal is or is not found 1306 to be met, then notice may be transmitted 1314 to the user describing the outcome of the deal and the method may end.

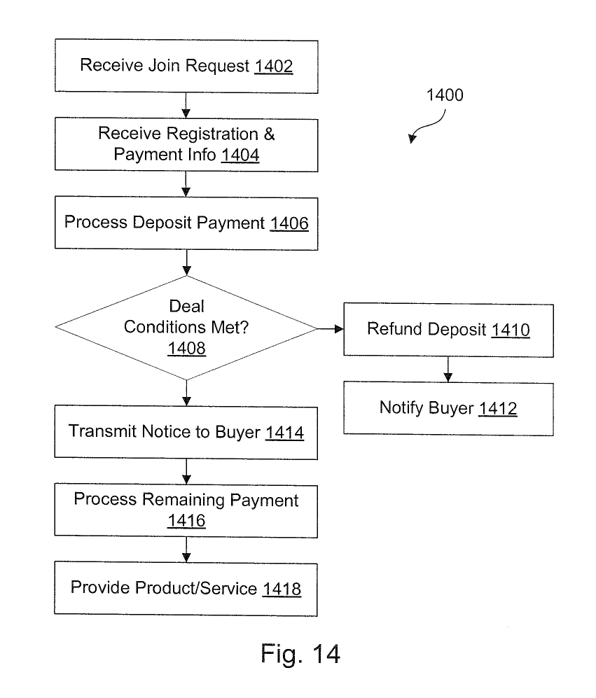

FIG. 14 illustrates another alternative method 1400 for managing acceptance and redemption of deals. The method 1400 may occur following creation and of a deal and transmission of the deal to prospects. The method 1400 may be performed by one or a combination of a server hosted by a provider of deal management services and a vendor who will fulfill the deal. The method may include receiving 1402 a request to join a deal and receiving and/or retrieving 1404 registration information and/or payment information. Payment of a deposit may then be processed 1406 by the deal management server or a vendor server.

If the conditions of the deal are not found 1408 to be met, then the deposit is refunded 1410 to the buyer and the buyer is notified 1412 that the deal will not occur. If the conditions of the deal are found 1408 to be met then notice may be transmitted 1414 to the buyer and payment of the remaining portion of the purchase price may be processed 1416 using the payment information received 1404. The product or service that is the subject of the deal may then be provided 1418 to the buyer.

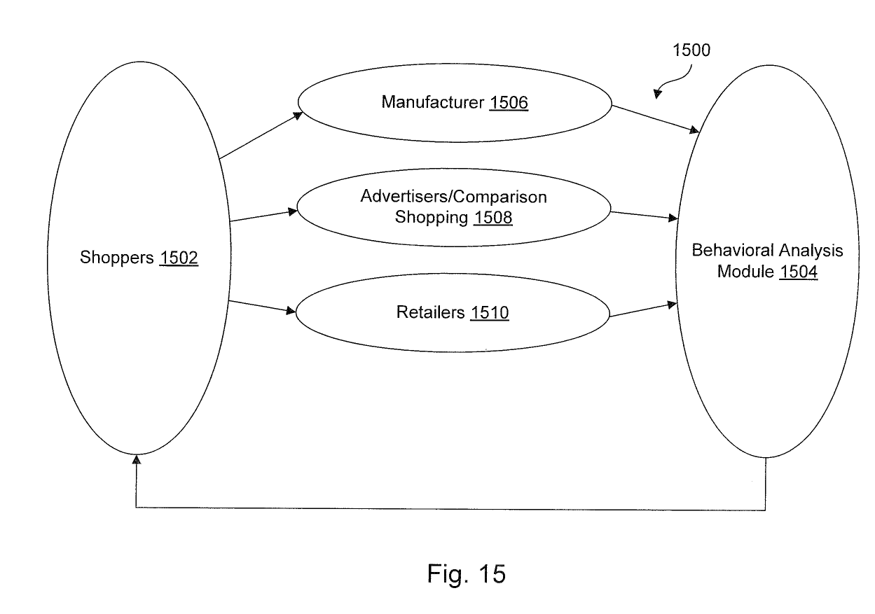

FIG. 15 illustrates a system 1500 that may be used to perform deal management methods as described herein. Shoppers 1502 generate information regarding their interests, preferences, demography, and the like, as they engage in online activity using user computing devices. This information may be used by a deal management system 1504 to configure deals and direct deals to prospects that have a likely interest according to the methods described herein. Information used to determine a prospect's interests may be transmitted to the deal management system by entities that interact with shoppers such as manufacturers 1506, advertisers and product comparison and rating sites 1508, and online and/or traditional brick-and-mortar retailers 1510.

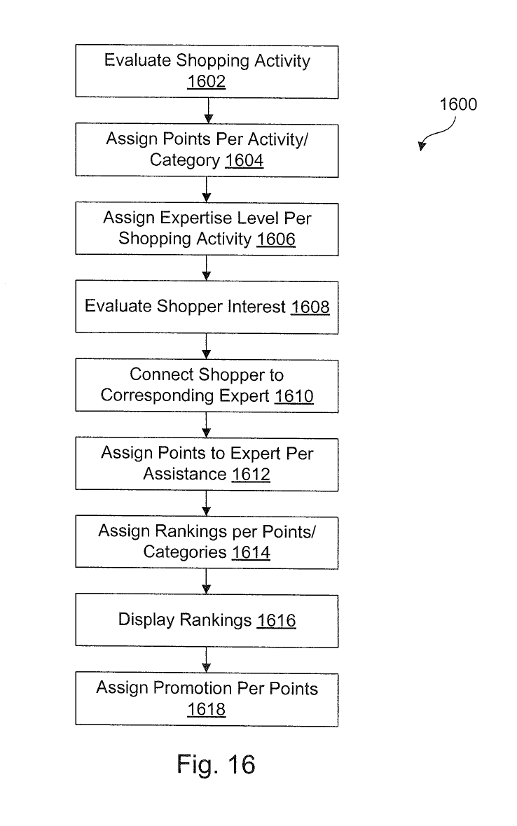

FIG. 16 illustrates a method for incentivizing users to engage in shopping activities, including both actual purchases as well as browsing, researching, reviewing, and other activities indicating interest, intent, opinions, and other expressions of a consumer's mental state. The method 1600 may be executed by one or both of a vendor server or a server provided by a deal management service. The method may include evaluating 1602 shopping activity, such as any of the shopping activities mentioned above. Points may be assigned 1604 to an individual for such activities. An individual may also be assigned 1606 an expertise level according to shopping activity. The expertise level assigned 1606 may also include the area of expertise, e.g. flat screen televisions, washers and dryers, digital cameras, or the like. For example, if a user is found to have spent significant time researching a class of product an expertise may be assigned 1606 corresponding to one or more of the number of articles read, number of product descriptions viewed, number of related postings made, and other activities relating to the class of product.

The method 1600 may further include evaluating 1608 a prospective shopper's interests according to an analysis of the above-mentioned shopping activity using any or all of the behavioral analysis techniques discussed herein or known in the art. The prospective shopper may then be connected 1610 to another individual having an assigned 1606 expertise level relating to the shopper's manifest interest determined at step 1608. This may include providing contact information of the expert to the prospective shopper, presenting a chat session to both the prospective shopper and expert, initiating a voice conversation, or any other form of communication. Points may be assigned 1612 to the expert for providing assistance.

Points may be compared and rankings assigned 1614 to individual according to points earned as described above. Points may be compared globally or only with respect to certain areas. For example, a user may be ranked 1614 according to a total number of points for all shopping activity detected at step 1602. Alternatively or in addition, a user may be ranked 1614 according to points earned for shopping activity or assistance provided relating to one or more of a product, product line, retailer, class of products, or the like.

Rankings may be displayed 1616 in the context of displaying shopping information to other users, such as a vendor website, website hosted by a provider of deal management services, or some other product related web site. As an example, an area of the screen may display 1616 one or more of a number of points for a high ranked user, area of interest in which the points were accumulated, an image of the user, the user's name or screen name, an indicator of the user's expertise and expertise area, and like information. A player's ranking, number of points, and or expertise, may be represented graphically, such as by a number of stars, a color code, or some other graphic representation.

Users may also be assigned 1618 promotions according to the points accumulated, such as an additional discount when participating in deals as discussed herein. Alternatively, the promotion may be in the form of a gift certificate, cash, or some other item or service of value to a user.

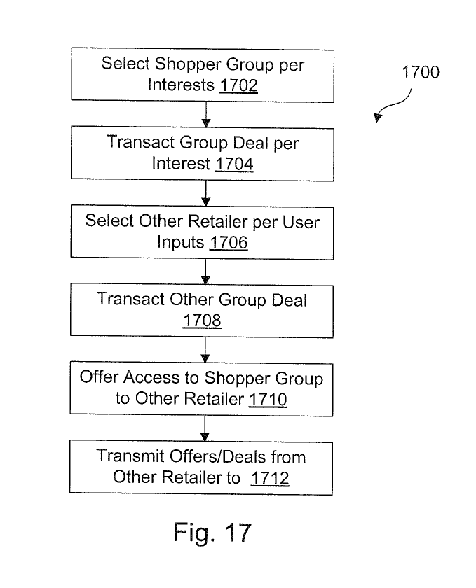

FIG. 17 illustrates a method 1700 for providing lateral buying and marketing in connection with a deal, such as a deal as described herein. The method 1700 may be executed by one or both of a vendor server or a server provided by a deal management service. The method 1700 may include selecting 1702 a shopper group or “swarm” of users according to a common interest discovered for the users as described hereinabove according to shopping activities. A group deal may then be transacted 1704, such as according to the methods described herein. The users of the group may then select 1706 another retailer or interest area. Selection 1706 may be performed by interaction between group members, a survey of group members, or selected automatically according to user shopping activities or based on an assumed relation between the previous deal and the selected retailer or interest area. Selection 1706 may also be performed manually by individuals associated with a deal management service. Selection 1706 may include purchasing by a vendor of the opportunity to offer a deal to the swarm members either at a fixed price or upon conclusion of an auction with other vendors.

Another deal may then be transacted 1708 with the group according to the selection step 1706. For groups selected according to an interest in a certain retailer, opportunities to market to the group may be offered 1710 to other retailers or entities likely to be of interest to the group. Offering 1710 may include conducting an auction among retailers to determine what other retailer will have the opportunity to make offers to the swarm. Bids are received from retailers and payment received from the winning bidder. Deal definition parameters may then be received from the winning bidder and used to provide a deal as described herein. Offers and deals as described herein may then be transmitted 1712 to the group by the other retailer or entity, or offers and deals relating to the other retailer or entity may be transmitted by or by means of the provider of deal management services. These deals may then be transacted such as according to the methods described herein.

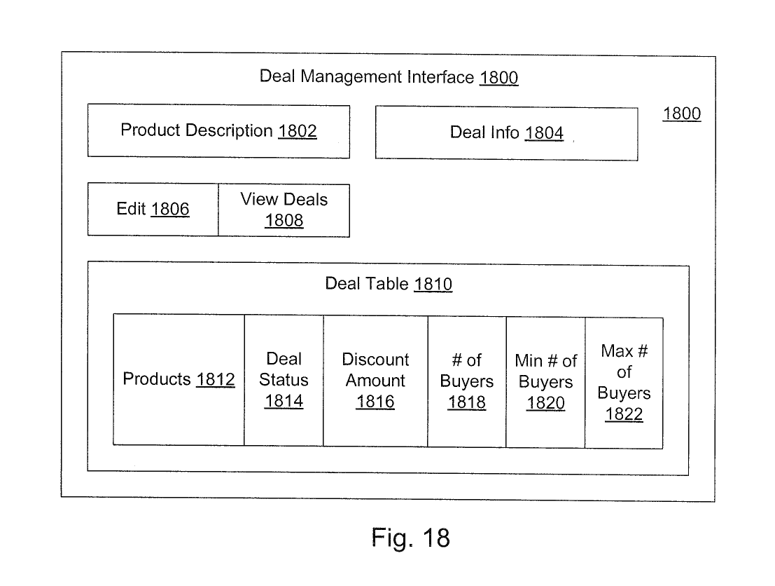

FIG. 18 illustrates a deal management interface. The functionality invoked using the deal management interface is described herein below. The described functionality may be performed by one or more servers of a deal management system. The deal management interface 1800 may include entry points for other interfaces for managing various aspects of a deal management system. In particular, the interface 1800 may be for use by vendors wishing to offer deal using the deal management system. For example, an interface provided for a vendor may include elements enabling a vendor to invoke display of the vendor's pending deals, invoke display of deals suggested by a the deal management system based on behavior analysis and parameters defined by the vendor, create new deals for processing according to the methods described herein, input parameters for controlling automatic generation of deals, define parameters for the creating and adding users to swarms of like minded prospective shoppers, and for changing other settings of the system.

FIG. 18 illustrates the deal management interface 1800 configured for enabling a vendor to view and edit pending deals. The interface 1800 may display a product description 1802 and deal information 1804 for a selected deal. The interface 1800 may further include an element 1806 enabling a vendor to edit the currently displayed deal. In some embodiments, the deal information 1804 may be a summary, such that an additional interface element 1808 is provided to invoke display of more details of the selected deal.

The interface 1800 may include a deal table 1810 listing one or both of active and previously closed deals. The deal table may include field such as a product identifier 1812, a deal status indicator 1814 (e.g., offered, building, activated, closed), a discount amount or percentage 1816, the number 1818 of buyers that have joined the deal as described herein, the minimum number 1820 of buyers that must accept before the deal is activated, and the maximum number 1822 of buyers that can participate in the deal. A deal may have various states such as “offered,” meaning made visible or transmitted to prospects, “building,” meaning that users are joining the deal but the minimum is not reached, “activated,” meaning that the minimum number of buyers have joined, and “closed,” meaning that the deal has either ended for failing to meet the conditions of the deal, or has concluded following redemption of the deal by joined buyers. Other parameters of the deal may also be displayed in the deal table 1810. The deal table 1810 may receive a user input to make a deal listed in the table the selected deal for display in the interface 1800.

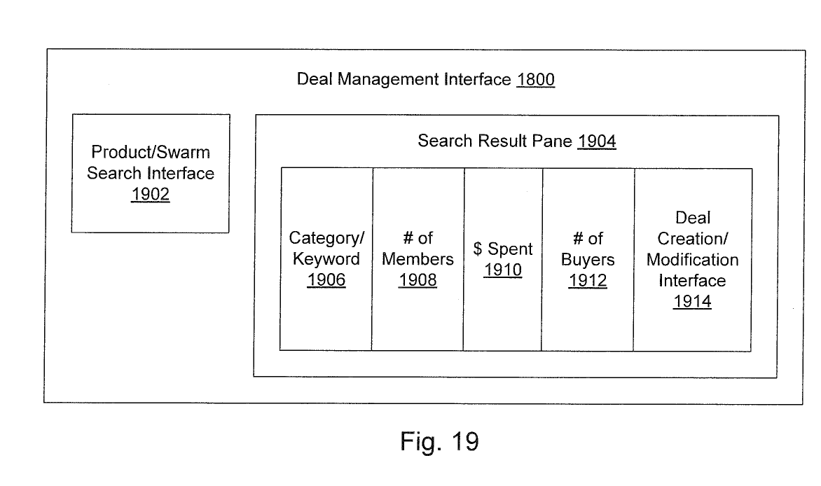

FIG. 19 illustrates a deal management interface 1800 enabling a vendor to choose groups of “swarms” of interested prospects to participate in a group deal as discussed herein. The interface 1800 may include swarm search interface 1902. The search interface 1902 may have fields to search by product, interest area, or by date of formation, i.e. search for groups formed within a specified number of days.

The interface 1800 may additionally include a search results table 1904 listing swarms matching search parameters input in the search interface 1902. For example, the table 1904 may include fields listing, the category or keyword 1906 describing the swarm's common interest, the number 1908 of members of the swarm, the amount 1910 of money spent by members of the swarm, and the number of buyers 1912 in the swarm (e.g., members that have actually purchased items corresponding to the swarm's common interest). Deal creation/modification interface elements 1914 may be displayed adjacent some or all of the entries in the table 1904 enabling a vendor to create and/or edit deals offered to the swarm associated with the entry.

In some embodiments, upon selection of an entry in the table 1904, the element may be expanded to show, or another table may be displayed to show, the sub-swarms included within the swarm corresponding to the selected entry. Entries corresponding to sub-swarms may also be selected to display entries for sub-sub swarms, and so on. For example, an entry corresponding to appliances may be expanded to show entries for swarms relating to specific appliances. In a like manner an entry relating to specific appliances may be expanded to show swarms corresponding to specific brand of appliance or a specific model. An entry for a sub-swarm directed to a specific product may include some or all of the fields mentioned above. An entry for a specific product may additionally or alternatively include one or more of, a product image, product model information, a retail or wholesale price, a margin indicator, a number left available for sale, and a number of engagements field or other behavioral information observed and associated with the product.

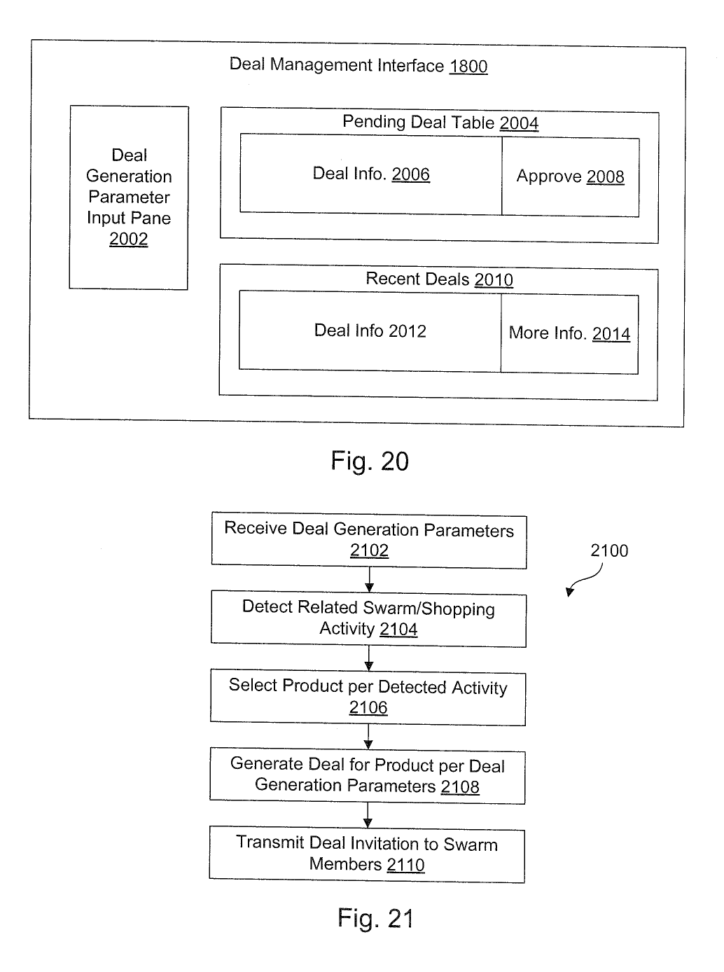

FIG. 20 illustrates an interface 1800 configured to enable a vendor to specify parameters for automatically generating deals. The deal management system may evaluate these parameters and generate deals offered to swarms of prospects likely to be interested in the subject of the deal. The interface 1800 may include a deal generation parameter input pane 2002. Parameters that may be input to the input pane 2002 may include such information as minimum deal revenue, maximum deal revenue, product rules (i.e. rules for selecting a product), maximum discount percentage, minimum product margin, maximum product price, and an automated publication permission indicator indicating whether deals can be published without additional approval from a vendor. The interface 1800 may additionally include a pending deal table 2004 listing information 2006 regarding pending deals and interface elements 2008 enabling a vendor to authorize publishing of deals. The interface 1800 may include a recent deal table 2010 listing deal information 2012 for recently published deals interface elements 2014 for invoking display of additional information for a selected deal from the table 2010.

FIG. 21 illustrates a method 2100 for automating the generation of deals. The method 2100 may be executed by one or both of a vendor server and a server forming part of a deal management system. The method 2100 includes receiving 2102 deal generation parameters, such as those mentioned above with respect to FIG. 20. Swarms engaging in shopping activity relating to the deal generation parameters may then be detected 2104 as described hereinabove. A product may be selected 2106 according to the detected activity and the deal generation parameters and deal may then be generated 2108 for the selected product according to the deal generation parameters. The deal may then be published to the swarm detected at step 2104. The deal may then proceed according to the methods described herein.

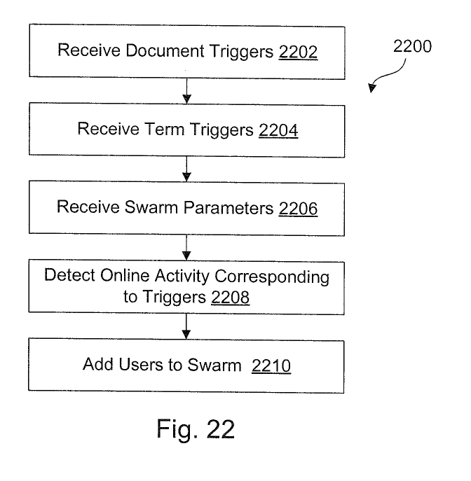

FIG. 22 illustrates a method 2200 for forming a swarm. The method 2200 may be executed by one or both of a vendor server and a server forming part of a deal management system. The method 2200 may include receiving 2202 document triggers from a vendor or other entity wishing to define a swarm. Document triggers may include URLs or other document identifiers for documents that may be viewed or requested by a user. Term triggers may also be received 2204. Term triggers may include one or more of terms typed by a user in a search field, chat or social networking posting, or elsewhere. Terms may also include text within web pages viewed by a user. In some embodiments, the entity defining the swarm parameters may specify where the terms occur in order to trigger inclusion of a user in a swarm (e.g., some or all of the occurrences of terms mentioned above). Other swarm definition parameters may also be received 2206 to define activity that is required to add a user to a swarm. Upon receiving 2202, 2204, 2206 the triggers and any other swarm parameters, activities corresponding to the triggers and/or parameters may be detected 2208. The users generating the triggering activity may then be added 2210 to a corresponding swarm. The swarm may then be used according to the methods described herein to generate group deals. The method 2200 may be executed in the context of the interface 1800 and fields for receiving 2202, 2204, 2206 the triggers and any other swarm parameters and user interface elements for invoking further execution of the method 2200 may be displayed in the interface 1800. Data describing one or more swarm definitions may also be displayed in the interface 1800.

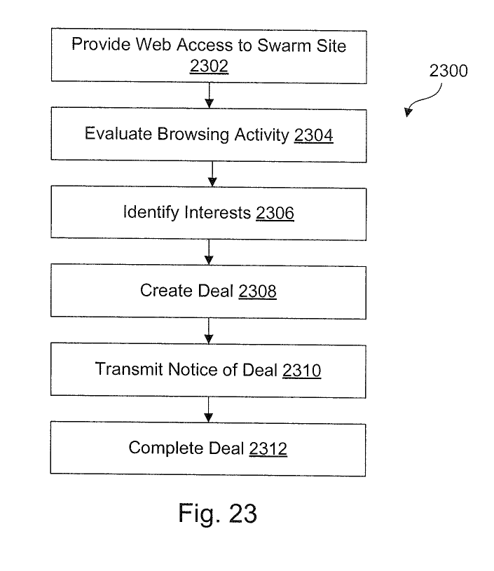

FIG. 23 illustrates a method 2300 for defining swarms directly by a deal management system. The method 2300 may include providing 2302 web access to a swarm site. The swarm site may be manifestly provided for the purpose of collecting information regarding a user's preferences, interests, opinions, etc. The web site may include content of interest to users such as reviews, research, comparison tools, games, and other interesting or entertaining elements. The browsing activities of users may be evaluated 2304 and swarms of users with common interests may be identified 2306 according to behavioral analysis methods. Deals may then be created 2308, transmitted 2310 to swarm members, and completed 2312 according to any of methods described hereinabove for transacting deals with prospects.

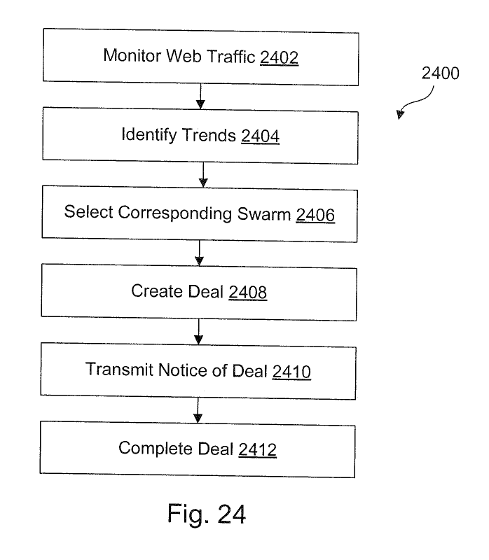

FIG. 24 illustrates a method 2400 for generating deals in accordance with current trends. The method 2400 includes monitoring 2402 web traffic. This may include receiving and reviewing statistics from another entity, such as a search engine or web analytics company. For example, the web traffic analyzed may include rankings of search terms, web sites, or other web activity. The web traffic may then be evaluated and current trends identified 2404. A trend may include a subject that is highly ranked or a subject that has a rapidly increasing rank, such as a search term that is rapidly increasing in usage. A swarm of users corresponding to the identified trend may then be selected 2406. The users of the swarm and the common interest defining the swarm may be defined before the trend is identified or afterward. In instances where the swarm is previously identified, the process of generating a deal corresponding to the identified trend can be accelerated to capitalize on market interest, which can be transitory. A deal corresponding to the selected swarm and the identified trend may then be created 2408, transmitted 2410 to the selected swarm, and completed 2412 according to the methods described hereinabove for transacting group deals with prospects.

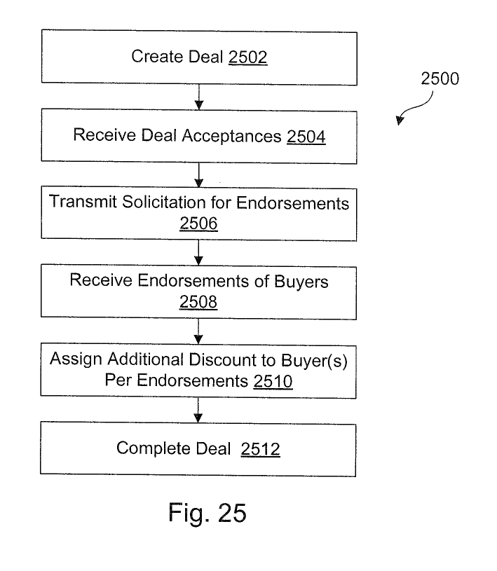

FIG. 25 illustrates a method 2500 for assigning discounts to a “member-in-need.” The method 2500 includes generating a deal 2502, such as according to methods described herein. Acceptances of the deal may then be received 2504, also as described herein. One or more users, who may or may not be members of the swarm, may transmit a solicitation for endorsements of one of the buyers that has accepted the deal. The solicitation may be made by means of a social networking posting, email, website link, or the like. Endorsements may then be received 2508 for the buyer. If the deal is activated according to the parameters of the deal, a user who has obtained a minimum number of endorsements may be assigned 2510 an additional discount for the product that is the subject of the deal. The deal may then be completed 2512 according to the methods described herein.

Embodiments of the system and method described herein facilitate configuring content of web and computer applications to improve user access to relevant content. Although the components and modules illustrated herein are shown and described in a particular arrangement, the arrangement of components and modules may be altered to perform analysis and configure content in a different manner. In other embodiments, one or more additional components or modules may be added to the described systems, and one or more components or modules may be removed from the described systems. Alternate embodiments may combine two or more of the described components or modules into a single component or module.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A method for behavior based marketing comprising:
evaluating, by a server computer, shopping activity of a plurality of users;
identifying, by the server computer, a swarm of users from the plurality of users, the swarm of users having at least one similar interest;
generating, by the server computer, a deal corresponding to the at least one similar interest; and
initiating, by the server computer, transmission of the deal to each user of the swarm of users.

2. The method of claim 1, further comprising:
receiving, by the server computer, acceptances of the deal from one or more accepting users of the swarm of users; and
processing, by the server computer, the acceptances.

3. The method of claim 2, wherein the deal defines a minimum acceptance number and purchase terms; and
wherein processing the acceptances further comprises:
evaluating, by the server computer, the number of acceptances with respect to the minimum acceptance number;
initiating, by the server computer, a purchase for each acceptance according to the purchase terms only if the number of acceptances are at least a large as the minimum acceptance number.

4. The method of claim 3, wherein the deal defines an acceptance window; and
wherein processing the acceptances further comprises:
evaluating, by the server computer, the a receipt date of each acceptance with respect to the acceptance window; and
initiating, by the server computer, the purchase according to the purchase terms for each acceptance received within the acceptance window only if the number of acceptances received within the acceptance window is at least as large as the minimum acceptance number.

5. The method of claim 3, wherein the acceptances each have payment information associated therewith; and
wherein initiating, by the server computer, a purchase according to the purchase terms for each acceptance further comprises processing payment using the payment information for the acceptance.

6. The method of claim 2, wherein processing the acceptances further comprises:
identifying a first to accept of the one or more accepting users; and
assigning an additional discount to the first to accept user.

7. The method of claim 2, further comprising:
receiving, by the server computer, one or more endorsements of a in-need user of the one or more accepting users; and
assigning, by the server computer, an additional discount to the in-need user according to the one or more endorsements.

8. The method of claim 1, wherein identifying, by the server computer, the swarm of users from the plurality of users further comprises:
receiving, by the server computer, specification of a qualifying activity;
detecting, by the server computer, the qualifying activity among the shopping activity by a user of the plurality of users; and
associating, by the server computer, the user with the swarm upon detecting the qualifying activity.

9. The method of claim 8, wherein the qualifying activity includes one or more of, viewing a specified document, browsing a specified uniform resource locator (URL); and typing a specified term.

10. The method of claim 1, wherein generating, by the server computer, the deal corresponding to the at least one similar interest further comprises:
automatically selecting, by the server computer, a product from a product selection associated with a vendor according to the at least one similar interest; and
generating, by the server, deal terms according to deal generation parameters associated with the vendor.

11. The method of claim 10, wherein the deal parameters include one or more of:
a minimum number of buyers, a maximum number of buyers, a time window, a discount amount, a discount percentage, a minimum margin, a minimum value, and a maximum value.

12. The method of claim 1, wherein the shopping activity includes shopping activity reported to the server computer from a vendor computer.

13. The method of claim 12, wherein shopping activity includes one or more of browsing, searching, and purchasing.

14. The method of claim 1, further comprising:
assigning, by the server computer, points to users of the plurality of users according to the shopping activity; and
assigning a discount to one or more of the plurality of users according to the assigned points.

15. The method of claim 14, further comprising transmitting for display on a user computer a ranking of a portion of the plurality of users according to assigned points.

16. The method of claim 1, further comprising:
assigning, by the server computer, an expertise area to one or more expert users of the plurality of users according to shopping activity of the one or more expert users; and
facilitating, by the server computer, communication by a novice user of the plurality of users with an expert user of the one more expert users upon detection of an area of interest of the novice user corresponding to the expertise area of the expert user.

17. A system for behavioral marketing comprising:
a server comprising a processor for executing executable data and process operational data and a memory operably coupled to the processor and storing operational and executable data operable to cause the processor to:
evaluate shopping activity for a plurality of users;
identify a swarm of users from the plurality of users, the swarm of users having at least one similar interest;
generate a deal corresponding to the at least one similar interest; and
initiate transmission of the deal to each user of the swarm of users.

18. The system of claim 17, wherein the operational and executable data are further operable to cause the processor to:
receive acceptances of the deal from one or more accepting users of the swarm of users; and
process the acceptances.

19. The system of claim 18, wherein the deal defines a minimum acceptance number and purchase terms; and
wherein the operational and executable data are further operable to cause the processor to process the acceptance by:
evaluating the number of acceptances with respect to the minimum acceptance number; and
initiating a purchase for each acceptance according to the purchase terms only if the number of acceptances are at least a large as the minimum acceptance number.

20. The system of claim 19, wherein the deal defines an acceptance window; and
wherein the operational and executable data are further operable to cause the processor to process the acceptance by:
evaluating the a receipt date of each acceptance with respect to the acceptance window; and
initiating the purchase according to the purchase terms for each acceptance received within the acceptance window only if the number of acceptances received within the acceptance window is at least as large as the minimum acceptance number.

21. The system of claim 19, wherein the acceptances each have payment information associated therewith; and
wherein the operational and executable data are further operable to cause the processor to process the acceptance by initiating the purchase according to the purchase terms for each acceptance further comprises processing payment using the payment information for the acceptance.

22. The system of claim 18, wherein the operational and executable data are further operable to cause the processor to process the acceptance by identifying a first to accept of the one or more accepting users and assigning an additional discount to the first to accept user.

23. The system of claim 2, wherein the operational and executable data are further operable to cause the processor to:
receive one or more endorsements of a in-need user of the one or more accepting users; and
assign an additional discount to the in-need user according to the one or more endorsements.

24. The system of claim 17, wherein the operational and executable data are further operable to cause the processor to identify the swarm of users from the plurality of users by:
receiving a specification of a qualifying activity;
detecting the qualifying activity among the shopping activity by a user of the plurality of users; and
associating the user with the swarm upon detecting the qualifying activity.

25. The system of claim 24, wherein the qualifying activity includes one or more of, viewing a specified document, browsing a specified uniform resource locator (URL); and typing a specified term.

26. The system of claim 17, wherein the operational and executable data are further operable to cause the processor to generate the deal corresponding to the at least one similar interest by:
automatically selecting a product from a product selection associated with a vendor according to the at least one similar interest; and
generating deal terms according to deal generation parameters associated with the vendor.

27. The system of claim 26, wherein the deal parameters include one or more of:
a minimum number of buyers, a maximum number of buyers, a time window, a discount amount, a discount percentage, a minimum margin, a minimum value, and a maximum value.

28. The system of claim 17, wherein the shopping activity includes shopping activity reported to the server computer from a vendor computer in data communication with the server computer.

29. The system of claim 28, wherein shopping activity includes one or more of browsing, searching, and purchasing.

30. The system of claim 17, wherein the operational and executable data are further operable to cause the processor to:
assign points to users of the plurality of users according to the shopping activity; and
assign a discount to one or more of the plurality of users according to the assigned points.

31. The system of claim 30, wherein the operational and executable data are further operable to transmit for display on a user computer a ranking of a portion of the plurality of users according to assigned points.

32. The system of claim 17, wherein the operational and executable data are further operable to:
assign an expertise area to one or more expert users of the plurality of users according to shopping activity of the one or more expert users; and
facilitate communication by a novice user of the plurality of users with an expert user of the one more expert users upon detection of an area of interest of the novice user corresponding to the expertise area of the expert user.
